(19) United States
(12) Patent Application Publication
(10) Pub. No.: US 2026/0298715 A1
(43) Pub. Date: Oct. 1, 2026

(54) FALSE ALARM IMMUNITY OF SINGLE SPECTRAL SENSOR USING MULTI-CHANNEL FREQUENCY SEGMENTATION

(71) Applicant: Spectronix Ltd., Sderot (IL)

(72) Inventors: Eyal BEN ARZI, Ashqelon (IL); Dimitriy GRIGOROVITCH, Be'er Sheva (IL); Tsviel BOUHBUT, Be’er Sheva (IL); Emil COHEN, Netivot (IL)

(21) Appl. No.: 19/089,155

(22) Filed: Mar. 25, 2025

(51) Int. Cl. G01J 5/00; G01J 5/0875; G08B 17/12

(52) U.S. Cl. CPC G01J 5/0018; G01J 5/0875; G08B 17/12

(57) ABSTRACT

An optical flame detection system includes a housing having a window and a single infrared sensor positioned proximate the window and configured to receive infrared illumination through the window. A digitizer is operably coupled to the single infrared sensor and is configured to provide a digital representation of an analog sensor signal obtained from the single infrared sensor. A processor is operably coupled to the digitizer and is configured to receive a series of time-spaced digital representations from the digitizer and classify individual representations into a plurality of groups. The processor is further configured to determine a first intensity value for a first group of the plurality of groups and a second intensity value for the second group of the plurality of groups. The processor is further configured to calculate a ratio between the first intensity value and the second intensity value and to compare the calculated ratio to a threshold to provide a flame detection decision output having improved false alarm immunity. A computer-implemented method of optical flame detection using a single infrared sensor is also provided.

### BACKGROUND

The process control and monitoring industry supports a wide range of process industries. Some of the process industries may employ or process materials that are highly flammable or even explosive. Examples of such industries include chemical processing facilities as well as petroleum extraction and refining. In such environments, fires and explosions are a significant hazard. In these highly volatile environments, it is useful and sometimes required to use one or more optical detectors, such as optical flame detectors, which detect any flame in the process environment so that such flame can be quickly extinguished.

Flame detection using a single infrared (IR) channel relies on identifying the unique IR radiation emitted by flames, typically around the 4.3 micrometer wavelength. An IR sensor tuned to this specific wavelength monitors for increases in IR intensity, which indicates the presence of a flame. The detected IR signal is then processed to confirm it matches the characteristic patterns of a flame, such as intensity and flicker frequency. Upon detection, the system triggers an alarm or initiates safety measures to address the potential fire hazard. This method is highly sensitive and provides rapid detection and is important for safety in industrial and fire alarm applications.

However, single IR flame detection can be prone to false alarms triggered by non-flame IR sources, such as sunlight or hot machinery. Providing a single IR flame detector with improved false alarm immunity would allow such single IR flame detectors to be used in more locations (e.g., sunlight or around hot machinery) and/or would allow flame detections from such single IR flame detectors to be more trustworthy.

### SUMMARY

An optical flame detection system is provided. The optical flame detection system includes a housing having a window and a single infrared sensor positioned proximate the window and configured to receive infrared illumination through the window. A digitizer is operably coupled to the single infrared sensor and is configured to provide a digital representation of an analog sensor signal obtained from the single infrared sensor. A processor is operably coupled to the digitizer and is configured to receive a series of time-spaced digital representations from the digitizer and classify individual representations into a plurality of groups. The processor is further configured to determine a first intensity value for a first group of the plurality of groups and a second intensity value for the second group of the plurality of groups. The processor is further configured to calculate a ratio between the first intensity value and the second intensity value and to compare the calculated ratio to a threshold to provide a flame detection decision output having improved false alarm immunity. A computer-implemented method of optical flame detection using a single infrared sensor is also provided.

### BRIEF DESCRIPTION OF THE DRAWINGS

FIG. 1 is a system block diagram of a multi-channel optical sensor with which embodiments described herein are particularly useful.

FIG. 2 is a flow diagram of a computer-implemented method of operating a single IR flame detector in accordance with an embodiment of the present invention.

FIG. 3 is a chart of signal intensity vs frequency illustrating interference source behavior in the frequency domain.

FIG. 4 is a chart of signal intensity vs frequency illustrating flame behavior in the frequency domain.

### DETAILED DESCRIPTION OF ILLUSTRATIVE EMBODIMENTS

Advanced, multi-IR flame detection uses multiple IR sensors and determines a ratio between the IR signal channels and reference channels as well as a correlation between frequency responses of all channels. However, single IR flame detection relies primarily on signal channel intensity. While multi-IR flame detection is useful, it is typically more costly than single IR flame detection. Thus, providing better false alarm protection for single IR flame detection would benefit the art.

Embodiments described herein reduce or prevent false alarms in flame detection systems that employ a single IR sensor. Traditional single-channel detectors, while effective in measuring optical energy, generally do not have the ability to discriminate between radiation emitted by genuine fire sources and that emitted by common false alarm triggers such as sunlight, fluorescent lights, or other non-flame heat sources. This limitation often results in high false alarm rates, leading to unnecessary disruptions and potentially compromising safety by desensitizing users to alarms.

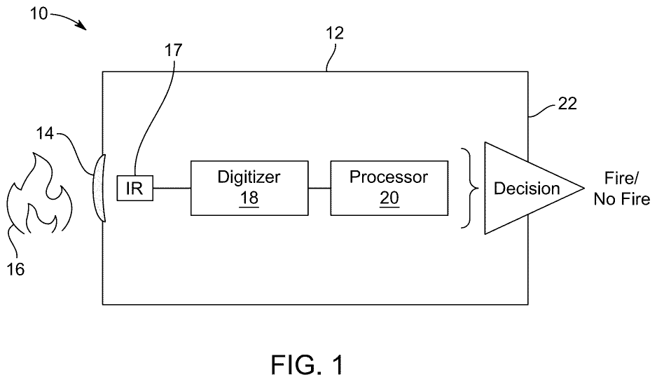

FIG. 1 is a system block diagram of a single-IR flame detection system with which embodiments described herein are particularly useful. System 10 includes a housing 12 having a lens 14 through which flames 16 are visible. Flames 16 emit a broad spectrum of infrared radiation. System 10 includes a single IR sensor 17 that is sensitive to the emission wavelengths (typically around 4.3 micrometers) of flames 16. Sensor 17 can be any suitable device that is sensitive to the wavelengths of flame. However, in some examples, sensor 17 is a pyroelectric sensor that can detect the rapid fluctuations in IR emitted by a flickering flame. When a flame is present, the changing IR radiation heats the pyroelectric material of a pyroelectric sensor, generating a voltage signal. Sensor 17 is operably coupled to digitizer 18, which includes circuitry to convert an analog signal of sensor 17 to a digital representation thereof. Digitizer 18 is coupled to processor 20 and is configured to provide the digital representation related to IR sensor 17 to processor 20.

Processor 20 is any suitable device that is able to execute programmatic steps or functions to provide various features of sensor 10. Examples of such devices include digital signal processors, microcontrollers, field programmable gate arrays, and application specific integrated circuits. In some examples, processor 20 is a microprocessor. Digitizer 18 provides digitized representations of the IR sensor signal to processor 20 for signal processing. Processor 20 processes the digitized signals from IR sensor 17 and analyzes the signal intensity and flicker frequency to detect the presence of flame 16.

When processor 20 confirms the presence of a flame, it generates an output 22, such as triggering an alarm and/or other suitable actions. Sensor 10 can also initiate automatic safety measures, such as shutting down equipment, initiating safety measures, and/or activating fire suppression systems.

Embodiments described herein generally utilize a single spectral sensor, such as sensor 17 and employ digital processing techniques to generate multi-band channel frequency segmentation. This new signal processing technique for single IR flame detection systems substantially mitigates false alarms. In one example, the digitized signals sampled from IR sensor 17 are transferred into frequency domain, using a Fast Fourier Transform (FFT).

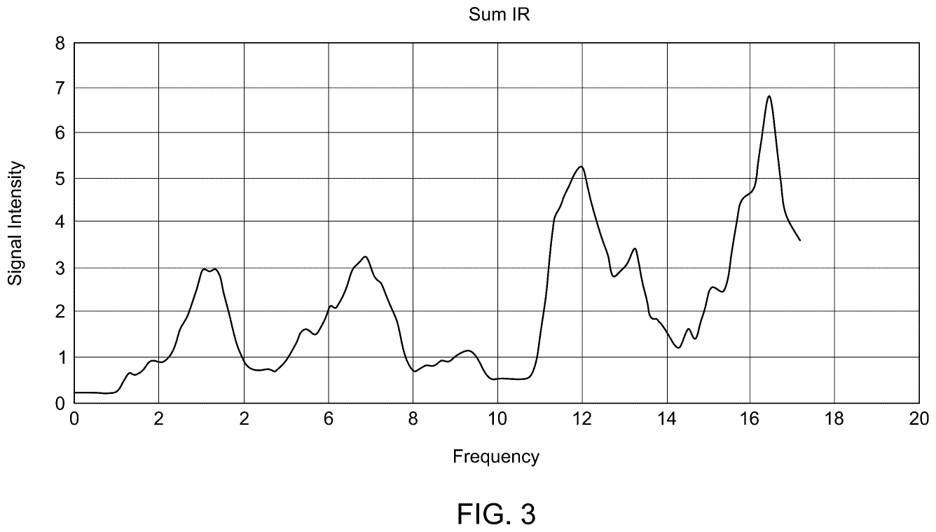

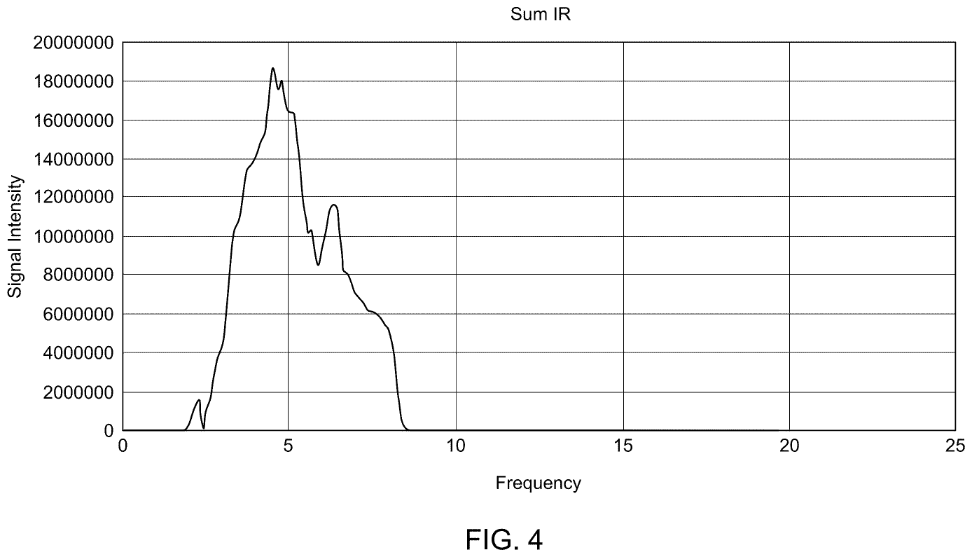

In the frequency domain, the processor is configured to detect frequencies typical of flame emission, approximately between 1-5 hz (see FIG. 4). Processor 20 is also configured to analyze the intensity of the signal from sensor 17 at high frequencies, approximately 5-15 Hz (see FIG. 3). While it is expected that real flame will have a very low response in those frequencies, a false alarm source, such as hot machinery, will cause a unified response over the whole frequency range.

By transforming the detected optical signal into the frequency domain and analyzing the ratio between different frequencies, embodiments described herein exploit the characteristic emission spectrum of real fires, which is concentrated at specific frequencies, as opposed to the broad frequency range emitted by most false alarm sources. This allows for the precise identification of genuine fire signatures, significantly reducing the likelihood of false alarms.

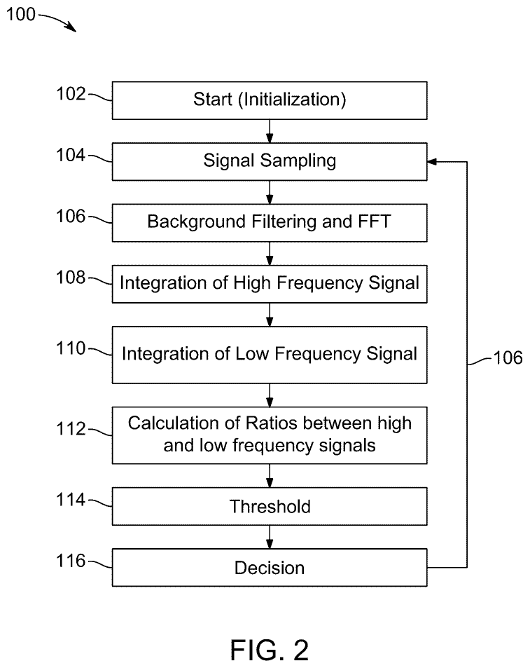

FIG. 2 is a flow diagram of a computer-implemented method of operating a single IR flame detector in accordance with an embodiment of the present invention. Method 100 begins at block 102 where the processor initiates the method. This may include clearing previous samples from memory and/or resetting buffers or registers. Next, at block 104, processor 20 performs signal sampling of the single IR sensor. In some examples, the single IR sensor may be a pyroelectric sensor. During block 104, a processor 20 receives a plurality of digital representations of the analog signal from sensor 17 spaced apart in time by a sampling frequency. For example, known pyroelectric sensors have a sufficient signal/noise ratio up to modulation frequencies of 4 kHz. During sampling, processor 20 stores a number of digital representations relative to the single-IR sensor. For example, in embodiments where the sampling frequency is 4 kHz and the sampling time is one second, processor 20 will store 4000 digital representations of the single IR sensor signal.

After signal sampling at block 104, processor 20 proceeds to block 106 where the stored samples are filtered. Preferably, this filtering process occurs as a background process for processor 20, if processor 20 is configured to provide background processing. In one example, the filtering may remove any DC component and/or 60 Hz. However, those skilled in the art will recognize that any suitable filtering can be performed at block 106, given that the signals of interest are generally between 1 and 15 Hz. At block 106, processor 20 also performs a Fast Fourier Transform of the stored data. FFT is one example of a transform that is useful for evaluating data samples in the frequency domain. However, any suitable transform can be used. The Fast Fourier Transform is a process that computes the Discrete Fourier Transform (DFT) of a sequence, or its inverse (IDFT). Fourier analysis converts a signal from its original domain (often time or space) to a representation in the frequency domain and vice versa. As a result of the FFT transform on the stored data, the data is segmented into data having a frequency between 1 and 5 Hz, which is defined herein as low frequency data and data having a frequency between 5 and 15 Hz, which is defined herein as high frequency data.

Next, at block 108, processor 20 integrates or otherwise adds the high frequency data to generate a high frequency intensity value. Similarly, at block 110, processor 20 integrates or otherwise adds the low frequency data to generate a low frequency intensity value. While the description of method 100 has block 108 occurring before block 110, it is expressly contemplated that block 110 may, in fact, occur before block 108 or occur simultaneously with block 108.

At block 112, processor 20 calculates a ratio between the high frequency intensity value and the low frequency intensity value. Processor 20 then compares the calculated ratio to a threshold as indicated at block 114. Based on the comparison between the calculated ratio and the threshold, processor 20 provides decision, as indicated at block 116, regarding whether the signal is indicative of flame. The threshold may be a pre-defined threshold that is entered into processor 20 during manufacture. In another example, the threshold may be based on a type of flame that is anticipated for the flame detection system. The type of flame may be selected by allowing a user to configure one or more jumpers or DIP switches in circuitry coupled to processor 20. In another example, the threshold may be user-adjustable. For example, processor 20 may be configured to adjust the threshold if a false alarm input is received from a user in response to a flame detection output.

The decision may be output locally as a fire alarm, transmitted to one or more remote devices or both. In the event that processor 20 determines that the signal is a false alarm, processor 20 may simply provide a no-flame decision output. However, it is expressly contemplated that the no-flame decision output may be supplemented with a false alarm indication thereby allowing personnel to investigate the source or sources causing the false alarm detection. As indicated at line 118, method 100 generally iterates by returning to block 104 to sample additional data from the single IR sensor 17.

FIG. 3 is a chart of signal intensity vs frequency illustrating interference source behavior in the frequency domain. As can be seen, for interference, the area under the curve from 1 to 5 Hz is significantly less than the area under the curve from 5 to 15 Hz. For example, High Signal Intensity/Low Signal Intensity is significantly more than 1.0

FIG. 4 is a chart of signal intensity vs frequency illustrating flame behavior in the frequency domain. As can be seen, the area under the curve for 1 to 5 Hz is similar to the area under the curve for 5 to 15 Hz. Thus, the ratio of high frequency to low frequency is much closer to 1.0 than the same ratio for interference (higher than 1). Thus, in one example, flame detection may be accomplished by comparing the ratio to a threshold of, for example, 1.2 and providing a flame output is the ratio is less than 1.2. Additional aspects, such as detecting overall signal intensity as well as flame flicker (such as frequency and/or magnitude of changes in intensity) can also be used in conjunction with the improved detection provided herein.

Compared to prior methods or devices that rely on single-frequency or multi-sensor approaches, embodiments described herein provide a number of advantages in terms of both effectiveness and efficiency. The use of a single sensor reduces system complexity, maintenance requirements, and costs, while the innovative frequency segmentation and calculation of ratio between intensity at different frequencies, enhances the detector's specificity to fire-related radiation. Consequently, embodiments described herein are believed to achieve superior false alarm immunity, ensuring a higher level of safety and operational integrity. This is accomplished without the need for multiple sensors or complex processing, leveraging the unique spectral signatures of fire to distinguish it from other infrared sources accurately.

Although the present invention has been described with reference to preferred embodiments, workers skilled in the art will recognize that changes may be made in form and detail without departing from the spirit and scope of the invention. While embodiments of the present invention have been described with respect to an optical flame sensor, it is expressly contemplated that other industries and applications would benefit from embodiments disclosed herein. For example, in agricultural crop monitoring, embodiments could be employed to detect stress in plants based on their infrared emission signatures. Different stress conditions, such as drought or disease, could alter the plant's typical infrared frequency spectrum, allowing for early intervention. In another example, embodiments could be employed for pollution detection and monitoring by detecting and quantifying pollutants in the air or water. The unique spectral signatures of various pollutants could be identified, allowing for targeted measures to reduce pollution levels. In still another example, industrial process control could employ embodiments to monitor and control industrial processes, such as chemical reactions or the quality of materials produced.

What is claimed is:

1. A computer-implemented method of optical flame detection using a single infrared sensor, the computer-implemented method comprising:
obtaining a number of samples from a single infrared sensor, the samples being spaced apart in time;
classifying the samples as high frequency samples and low frequency samples;
adding high frequency samples together to provide a high frequency intensity value;
adding low frequency samples together to provide a low frequency intensity value;
calculating a ratio between the high frequency intensity value and the low frequency intensity value;
comparing the ratio to a threshold; and
selectively providing a flame detection based on comparing the ratio to the threshold.

2. The computer-implemented method of claim 1, wherein the flame detection has improved false alarm immunity.

3. The computer-implemented method of claim 1, wherein flame detection is also provided based on a flicker frequency calculated from the number of samples from the single infrared sensor.

4. The computer-implemented method of claim 1, wherein classifying the samples as high frequency samples and low frequency samples includes applying a Fast Fourier Transform to the samples obtained from the single infrared sensor.

5. The computer-implemented method of claim 4, wherein low frequency samples have a frequency between 1 and 5 Hz.

6. The computer-implemented method of claim 4, wherein high frequency samples have a frequency between 5 and 15 Hz.

7. The computer-implemented method of claim 1, and further comprising filtering the samples before classifying the samples as low frequency samples and high frequency samples.

8. The computer-implemented method of claim 7, wherein filtering the samples occurs as a background process.

9. The computer-implemented method of claim 1, wherein the threshold is based on an anticipated flame type.

10. The computer-implemented method of claim 1, wherein the threshold is user-adjustable.

11. An optical flame detection system comprising:
a housing having a window;
a single infrared sensor positioned proximate the window and configured to receive infrared illumination through the window;
a digitizer operably coupled to the single infrared sensor and being configured to provide a digital representation of an analog sensor signal obtained from the single infrared sensor; and
a processor operably coupled to the digitizer, the processor being configured to receive a series of time-spaced digital representations from the digitizer and classify individual representations into a plurality of groups, the processor being further configured to determine a first intensity value for a first group of the plurality of groups and a second intensity value for the second group of the plurality of groups, the processor being further configured to calculate a ratio between the first intensity value and the second intensity value and to compare the calculated ratio to a threshold to provide a flame detection decision output having improved false alarm immunity.

12. The optical flame detection system of claim 11, wherein the first group is a low frequency group.

13. The optical flame detection system of claim 12, wherein the low frequency group is selected from a frequency between 1 Hz and 5 Hz.

14. The optical flame detection system of claim 11, wherein the second group is a high frequency group.

15. The optical flame detection system of claim 14, wherein the high frequency group is selected from a frequency between 5 Hz and 15 Hz.

16. The optical flame detection system of claim 11, wherein the processor is configured to perform a transform operation on the series of time-spaced digital representations to transform the series of time-spaced digital representations to a frequency domain.

17. The optical flame detection system of claim 16, wherein the transform is a Fast Fourier Transform.

18. The optical flame detection system of claim 11, wherein the single infrared sensor is a pyroelectric sensor.

19. The optical flame detection system of claim 11, wherein the single infrared sensor is sensitive to illumination having a wavelength of around 4.3 micrometers.
